(19) United States
(12) Patent Application Publication
(10) Pub. No.: US 2018/0155063 A1
(43) Pub. Date: Jun. 7, 2018

(54) SYSTEMS AND METHODS FOR DIAGNOSING TURBOSHAFT ENGINE BLEED VALVES

(71) Applicant: Sikorsky Aircraft Corporation, Stratford, CT (US)

(72) Inventor: Brian D. LeFevre, Webster, NY (US)

(21) Appl. No.: 15/736,260

(22) PCT Filed: Jun. 14, 2016
(86) PCT No.: PCT/US2016/037399

§ 371 Date: Dec. 13, 2017

Related U.S. Application Data
(60) Provisional application No. 62/181,623, filed on Jun. 18, 2015.

(51) Int. Cl. B64F 5/60; F02C 9/18; G07C 5/00

(52) U.S. Cl. CPC B64F 5/60; F02C 9/18; G07C 5/006; B64D 15/04; F05D 2260/85; F05D 2270/303; F05D 2260/80

(57) ABSTRACT

A method for diagnosing the function of an anti-ice/start bleed valve (AISBV) includes determining an operating mode of an engine and retrieving current engine system data associated with the operating mode. The method includes indicating whether the AISBV is functioning properly based on the current engine system data. An AISBV assessment system includes an AISB V assessment module configured to be operatively connected to a plurality of sensors. The AISBV assessment module includes a processor operatively connected to a memory, wherein the memory includes instructions recorded thereon that, when read by the processor, cause the processor to determine an operating mode of an engine, retrieve current engine system data associated with the operating mode, and indicate whether an AISBV is functioning properly based on the current engine system data.

### CROSS REFERENCE TO RELATED APPLICATIONS

This application claims benefit of U.S. Provisional Application No. 62/181,623, filed Jun. 18, 2015, the entire disclosure of which is hereby incorporated herein by reference in its entirety.

### STATEMENT REGARDING FEDERALLY SPONSORED RESEARCH OR DEVELOPMENT

This invention was made with government support under contract number W911 W6-10-2-0006 awarded by the United States Army. The government has certain rights in the invention.

### BACKGROUND OF THE INVENTION

### 1. Field of the Invention

The present disclosure relates to bleed valves employed on gas turbine engines, and more particularly to anti-ice/start bleed valves (AISBVs).

### 2. Description of Related Art

Many aircraft, for example, rotorcraft, include gas turbine engines having bleed valves. Typically, for an AISBV, bleed air is siphoned from hot sections of the engine through the AISBV and can be used to heat other engine or aircraft components that tend to be prone to icing. Maintenance of engines due to malfunctioning components internal to the AISBV can be a significant maintenance driver in some aircraft. Existing maintenance checks are manual, for example visual inspection and dedicated procedures which must be executed by the pilot or flight crew. Manual maintenance checks are not always accurate, which can lead to unnecessary labor and expense, for example, ground runs, and potentially unwarranted engine removals.

Such conventional methods and systems have generally been considered satisfactory for their intended purpose. However, there is still a need in the art for improved methods and systems for diagnosing functionality of AISBVs. The present disclosure provides a solution for this need.

### SUMMARY OF THE INVENTION

A method for diagnosing the function of an anti-ice/start bleed valve (AISBV) includes determining an operating mode of an engine and retrieving current engine system data associated with the operating mode. The method includes indicating whether the AISBV is functioning properly based on the current engine system data.

Indicating whether an AISBV is functioning properly can include generating an alert signaling a need for a maintenance action. Determining the operating mode can include determining the engine power and outside air temperature and associating the engine power and outside air temperature with a respective engine operating mode from a model. The operating mode can be at least one of mode 1, mode 2, or mode 3. In mode 1, the current engine system data can include an AISBV status, wherein the AISBV status is at least one of open or closed. In mode 1, indicating whether the AISBV is functioning properly can include generating a no-fault condition indicator if the AISBV status is open and generating a fault condition indicator if the AISBV status is closed.

In mode 2, the method can include retrieving baseline data and the current engine system data can include an AISBV status. The AISBV status can be at least one of open or closed. The baseline data can include an AISBV switch status. The AISBV switch status can be at least one of off or on. Indicating whether the AISBV is functioning properly can include generating a no-fault condition indicator if the AISBV switch status is off. The method can include comparing the current engine system data to the baseline data if the AISBV switch status is on. Comparing the current engine system data to the baseline data can include comparing the AISBV status to the AISBV switch status. The AISBV status matches the AISBV switch status when the AISBV switch is on and the AISBV is open. The AISBV status does not match the AISBV switch status when the AISBV switch is on and the AISBV is closed. Indicating whether the AISBV is functioning properly can include generating a no-fault condition indicator if the AISBV status matches the AISBV switch status, and generating a fault condition indicator if the AISBV status and the AISBV switch status do not match. The method can include retrieving the AISBV status from an AISBV sensor operatively connected to the AISBV.

In mode 3, the method can include retrieving baseline data. Retrieving baseline data can include retrieving and saving the baseline data. Baseline data can include at least one of an AISBV status, torque, or gas path temperature measurement from the engine from a point before changing the AISBV switch status. Retrieving current engine system data can include retrieving and saving the current engine system data. Current engine system data can include at least one of an AISBV status, torque, or gas path temperature measurement from the engine from a point after changing the AISBV switch status. The method can include comparing the current engine system data to the baseline data. Comparing the current engine system data to the baseline data can include comparing the current engine system data from the point after changing the AISBV switch status to the baseline data from the point before changing the AISBV switch status. Comparing the current engine system data to the baseline data can include determining the difference between the torque measurement from the point before changing the AISBV switch status and the torque measurement from the point after changing the AISBV switch status and comparing the difference to a pre-determined torque threshold.

In mode 3, if the difference between the torque measurement from the current engine system data and the torque measurement from the baseline data is greater than pre-determined torque threshold, the method can include determining an elapsed time between when the baseline data was retrieved and when the current engine system data was retrieved and comparing the elapsed time with a pre-determined elapsed time threshold. The method can include generating a no-fault condition indicator if the elapsed time is less than the pre-determined elapsed time threshold. The method can include generating a fault condition indicator where the AISBV status does not match the AISBV switch status and the elapsed time is greater than the pre-determined elapsed time threshold.

In mode 3, if the difference between the torque measurement from the current engine system data and the torque measurement from the baseline data is less than the pre-determined torque threshold, the method can include determining an elapsed time between when the baseline data was retrieved and when the current engine system data was retrieved, and comparing the elapsed time with at least one of first and second pre-determined elapsed time thresholds. The method can include generating a no-fault condition indicator if the elapsed time is less than the first pre-determined elapsed time threshold. If the elapsed time is between the first and second pre-determined elapsed time thresholds, the method can include generating a no-fault condition indicator where the AISBV status matches the AISBV switch status. If the elapsed time is between the first and second pre-determined elapsed time thresholds the method can include generating a fault condition indicator where the AISBV status does not match the AISBV switch status.

In mode 3, if the difference between the torque measurement from the current engine system data and the torque measurement from the baseline data is less than the pre-determined torque threshold and if the elapsed time is greater than the second pre-determined elapsed time threshold, comparing the current engine system data to the baseline data can include determining a change in gas path temperature between the gas path temperature measurement from the current engine system data and the gas path temperature measurement from the baseline data, and comparing the change in gas path temperature to a pre-determined gas path temperature threshold. The method can include generating a fault condition indicator if the change in gas path temperature is less than the pre-determined gas path temperature change threshold, or if the AISBV status does not match the AISBV switch status. The method can include generating a no-fault condition indicator if the change in gas path temperature is greater than the pre-determined gas path temperature change threshold and if the AISBV status matches the AISBV switch status.

An AISBV assessment system includes an AISBV assessment module configured to be operatively connected to a plurality of sensors. The AISBV assessment module includes a processor operatively connected to a memory, wherein the memory includes instructions recorded thereon that, when read by the processor, cause the processor to determine an operating mode of an engine, retrieve current engine system data associated with the operating mode, and indicate whether an AISBV is functioning properly based on the current engine system data. The system can include a plurality of sensors disposed in an aircraft and/or the aircraft engine operatively connected to the AISBV assessment module. The system can include an AISBV operatively connected to the engine and to at least one of the sensors. An AISBV switch can be operatively connected to the AISBV.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic view of an exemplary embodiment of a vertical take-off and landing (VTOL) aircraft, showing an AISBV assessment system constructed in accordance with the present disclosure;

FIG. 2 is a schematic view of the AISBV assessment system of FIG. 1, showing the AISBV and a plurality of sensors; and

FIG. 3 is a flowchart of an exemplary method for diagnosing functionality of the AISBV in accordance with the present disclosure, showing operations for comparing current engine system data to baseline data.

### DETAILED DESCRIPTION OF THE PREFERRED EMBODIMENTS

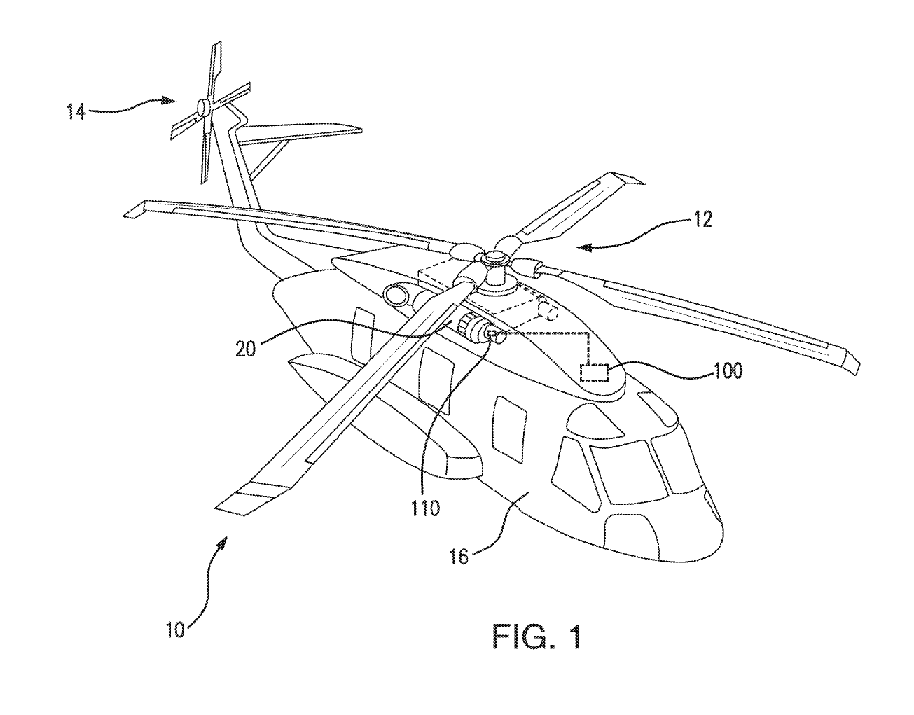

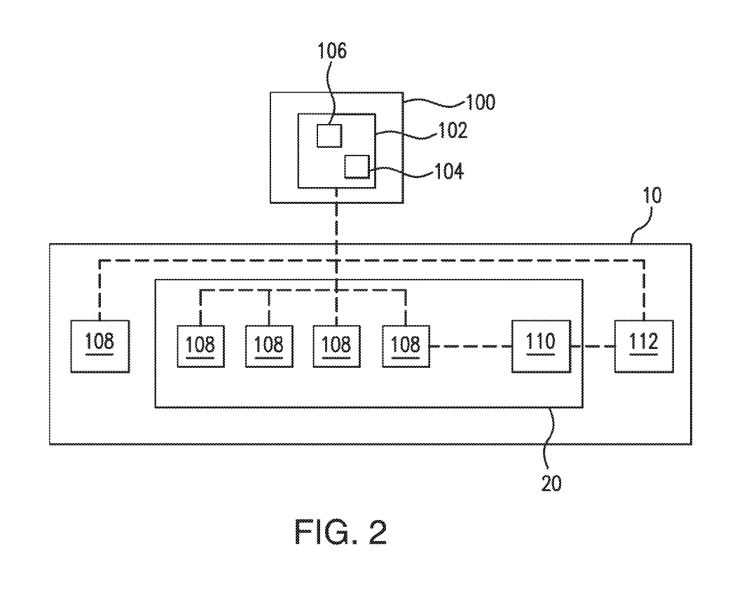

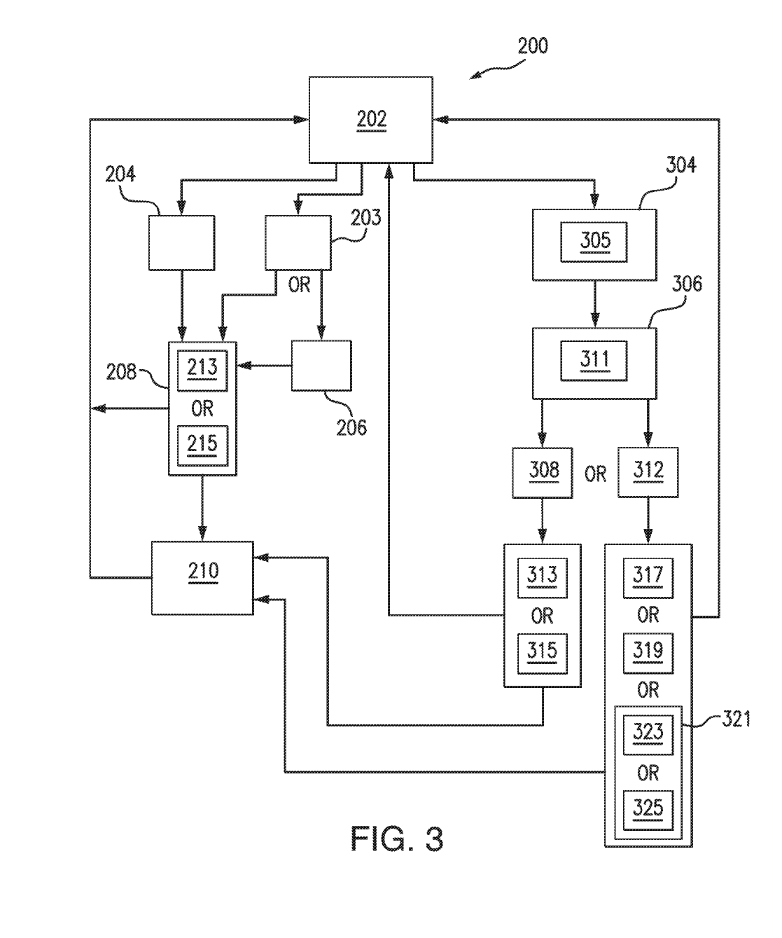

Reference will now be made to the drawings wherein like reference numerals identify similar structural features or aspects of the subject disclosure. For purposes of explanation and illustration, and not limitation, a partial view of an exemplary embodiment of a vertical takeoff and landing (VTOL) aircraft in accordance with the disclosure is shown in FIG. 1 and is designated generally by reference character 10. Other embodiments of VTOL aircraft in accordance with the disclosure, or aspects thereof, are provided in FIGS. 2-3, as will be described. The systems and methods described herein alleviate maintenance burden by reducing and/or eliminating manual maintenance procedures, and minimize possibility of wasted maintenance effort and costs due to misdiagnosis, e.g. reducing the probability of turboshaft engines being removed with ‘no fault found’.

As shown in FIG. 1, VTOL aircraft 10 includes a main rotor system 12 and tail rotor system 14 supported by an airframe 16. Airframe 16 also includes an anti-ice/start bleed valve (AISBV) assessment system 100. An AISBV 110 is operatively associated with engine 20 and with AISBV assessment system 100. Those skilled in the art will readily appreciate that while AISBV assessment system 100 and AISBV 110 are described in the context of a VTOL aircraft, system 100 and AISBV 110 can be used in a variety of aerospace and industrial applications. Moreover, while shown on VTOL aircraft 10, AISBV assessment system 100 can also be outside of aircraft 10 but operatively connected thereto, for example, through wireless communication.

As shown in FIG. 2, AISBV assessment system 100 includes an AISBV assessment module 102. Module 102 includes a processor 104 operatively connected to a memory 106. AISBV assessment module 102 is operatively connected to a plurality of sensors 108 and an AISBV switch 112. Sensors 108 are disposed throughout aircraft 10 and engine 20. AISBV 110 is operatively connected to at least one of sensors 108. At least one sensor 108 is disposed outside of engine to measure Outside Air Temperature (OAT). Sensors 108 within engine 20 include, for example, a gas generator shaft speed sensor, a torque sensor, a temperature sensor, e.g. a T45 sensor, and/or an AISBV status sensor. Those skilled in the art will readily appreciate that AISBV switch 112 can be located in the cockpit or other control location and is operatively connected to AISBV 110 and to AISBV assessment module 102. Memory 106 includes instructions recorded thereon that, when read by processor 104, cause processor 104 to perform the method described below.

As shown in FIG. 3, a method 200 for diagnosing the function of an AISBV, e.g.

AISBV 110, includes determining an operating mode of an engine by determining the engine power and outside air temperature and associating the engine power and OAT with a respective engine operating mode from a model, as indicated by box 202. The operating mode is one of mode 1, mode 2, or mode 3. Mode 1 is associated with low engine power, e.g. start up or light engine loading, mode 2 is associated with intermediate engine power, e.g. moderate engine loading, and mode 3 is associated with high engine power, e.g. acceleration or heavy engine loading.

In mode 1, after determining the operating mode, method 200 includes retrieving current engine system data associated with the operating mode, as indicated by box 204. The current engine system data includes the AISBV status, e.g. one of open or closed. It is contemplated that the AISBV status can be retrieved from an AISBV sensor operatively connected to the AISBV. Indicating whether the AISBV is functioning properly, as shown in box 208, includes generating a no-fault condition indicator if the AISBV status is open, as shown by box 213, and generating a fault condition indicator if the AISBV status is closed, as shown by box 215. Method 200 includes generating an alert signaling a need for a maintenance action, as indicated by box 210, should a fault condition be indicated, as described in more detail below. Those skilled in the art will readily appreciate that if no fault is found, method 200 can begin again. If fault is found and an alert is issued, it is also contemplated that method 200 can begin again. Method 200 can be run as a continuous loop, or upon user command.

With continued reference to FIG. 3, for mode 2, the method includes retrieving current engine system data and baseline data associated with the operating mode, as indicated by box 203. Current engine system data includes the AISBV status and the baseline data includes an AISBV switch status. The AISBV status is at least one of open or closed. The AISBV switch status is at least one of off or on. If the AISBV switch status is off, indicating whether the AISBV is functioning properly, as shown in box 208, includes generating a no-fault condition indicator, as shown by box 213. If the AISBV switch status is on, the method includes comparing the current engine system data to baseline data by comparing the AISBV status to the AISBV switch status, as indicated by box 206.

The AISBV status matches the AISBV switch status when the AISBV switch is on and the AISBV is open. The AISBV status does not match the AISBV switch status when the AISBV switch is on and the AISBV is closed. Indicating whether the AISBV is functioning properly, as shown in box 208, includes generating a no-fault condition indicator if the AISBV status matches the AISBV switch status, as indicated by box 213, and indicating a fault condition indicator if the AISBV status and the AISBV switch status do not match, as indicated by box 215. Those skilled in the art will readily appreciate that if no fault is found method 200 can begin again. If fault is found and an alert is issued, it is also contemplated that method 200 can begin again. Method 200 can be run as a continuous loop, or upon user command.

With continued reference to FIG. 3, after determining the operating mode of the engine, as indicated by box 202, if it is determined that the operating mode is mode 3, the method includes retrieving baseline data and current engine system data associated with the operating mode, indicated by box 304, and also includes saving the baseline data and the current engine system data, as indicated by box 305. Baseline data for mode 3 includes an AISBV status, a torque, and/or a gas path temperature measurement taken from the engine from a point before changing the AISBV switch status. Current engine system data includes an AISBV status, a torque, and/or a gas path temperature measurement taken from the engine from a point after changing the AISBV switch status. Method 200 includes comparing the current engine system data to the baseline data, as indicated by box 306. Comparing the current engine system data to the baseline data includes determining the difference between the torque from a point before changing the AISBV switch status and the torque from the engine from a point after changing the AISBV switch status and comparing the difference to a pre-determined torque threshold, as indicated by box 311.

With continued reference to FIG. 3, if the difference between the torque measurement from the current engine system data and the torque measurement from the baseline data is greater than a pre-determined torque threshold, method 200 includes determining an elapsed time between when the baseline data was retrieved and when the current engine system data was retrieved and comparing the elapsed time with a pre-determined elapsed time threshold, as indicated by box 308. If the elapsed time is less than the pre-determined elapsed time threshold, method 200 includes generating a no-fault indicator, as indicated by box 313, as insufficient time has passed to allow the valve to respond to the command signal. If the elapsed time is greater than the pre-determined elapsed time threshold (i.e. the valve has had sufficient time to respond to the pilot's command), but the AISBV status does not match the AISBV switch status, method 200 includes generating a fault condition indicator, as indicated by box 315.

In mode 3, if the difference between the torque measurement from the current engine system data and the torque measurement from the baseline data is less than the pre-determined torque threshold, method 200 includes determining an elapsed time between when the baseline data was retrieved and when the current engine system data was retrieved, and comparing the elapsed time with at least one of first and second pre-determined elapsed time thresholds, as indicated by box 312. If the elapsed time is less than the first pre-determined elapsed time threshold, since insufficient evidence exists to declare a fault, method 200 includes generating a no-fault condition indicator, as indicated by box 317. If the elapsed time is between the first and second pre-determined elapsed time thresholds and the AISBV status matches the AISBV switch status, method 200 also includes generating a no-fault condition indicator, as indicated by box 317. If the elapsed time is between the first and second pre-determined elapsed time thresholds method 200 includes generating a fault condition indicator where the AISBV status does not match the AISBV switch status, as indicated by box 319.

If the elapsed time is greater than the second pre-determined elapsed time threshold, comparing the current engine system data to the baseline data includes determining a change in gas path temperature between the gas path temperature from the current engine system data and the gas path temperature from the baseline data, and comparing the change in gas path temperature to a pre-determined gas path temperature threshold, as indicated by box 321. If the change in gas path temperature is less than the pre-determined gas path temperature change threshold, or if the AISBV status does not match the AISBV switch status, method 200 includes generating a fault condition indicator, as indicated by box 323. If the change in gas path temperature is greater than the pre-determined gas path temperature change threshold and if the AISBV status matches the AISBV switch status, method 200 includes generating a no-fault condition indicator, as indicated by box 325. Those skilled in the art will readily appreciate that if no fault is found method 200 can begin again. If fault is found and an alert is issued, it is also contemplated that method 200 can begin again. Method 200 can be run as a continuous loop, or upon user command.

The methods and systems of the present disclosure, as described above and shown in the drawings, provide for systems and methods for diagnosing AISBV function that provide optimization of maintenance of engines, and reduction in maintenance time and costs. While the apparatus and methods of the subject disclosure have been shown and described with reference to preferred embodiments, those skilled in the art will readily appreciate that changes and/or modifications may be made thereto without departing from the spirit and scope of the subject disclosure.

What is claimed is:

1. A method for diagnosing the function of an anti-ice/start bleed valve, the method comprising:
determining an operating mode of an engine;
retrieving current engine system data associated with the operating mode; and
indicating whether an anti-ice/start bleed valve (AISBV) is functioning properly based on the current engine system data.

2. A method as recited in claim 1, wherein indicating whether the AISBV is functioning properly includes generating an alert signaling a need for a maintenance action.

3. A method as recited in claim 1, wherein determining the operating mode includes determining the engine power and outside air temperature and associating the engine power and outside air temperature with a respective engine operating mode from a model.

4. A method as recited in claim 1, wherein the operating mode is at least one of mode 1, mode 2, or mode 3, wherein mode 1 is associated with low engine power, mode 2 is associated with intermediate engine power, and mode 3 is associated with high engine power.

5. A method as recited in claim 4, wherein in mode 1 the current engine system data includes an AISBV status, wherein the AISBV status is at least one of open or closed, wherein indicating whether the AISBV is functioning properly includes generating a no-fault condition indicator if the AISBV status is open and generating a fault condition indicator if the AISBV status is closed.

6. A method as recited in claim 4, further comprising retrieving baseline data, wherein in mode 2 the current engine system data includes an AISBV status, wherein the AISBV status is at least one of open or closed, wherein the baseline data includes an AISBV switch status, wherein the AISBV switch status is at least one of off or on, wherein indicating whether the AISBV is functioning properly includes generating a no-fault condition indicator if the AISBV switch status is off.

7. A method as recited in claim 6, further comprising comparing the current engine system data to the baseline data if the AISBV switch status is on, wherein comparing the current engine system data to the baseline data includes comparing the AISBV status to the AISBV switch status, wherein the AISBV status matches the AISBV switch status when the AISBV switch is on and the AISBV is open, and wherein the AISBV status does not match the AISBV switch status when the AISBV switch is on and the AISBV is closed, and wherein indicating whether the AISBV is functioning properly includes generating a no-fault condition indicator if the AISBV status matches the AISBV switch status, and generating a fault condition indicator if the AISBV status and the AISBV switch status do not match.

8. A method as recited in claim 4, further comprising retrieving baseline data, wherein in mode 3 retrieving the baseline data includes retrieving and saving the baseline data, wherein the baseline data includes at least one of an AISBV status, a torque, or a gas path temperature measurement from the engine from a point before changing an AISBV switch status, wherein retrieving current engine system data includes retrieving and saving current engine system data, wherein current engine system data includes at least one of an AISBV status, a torque, or a gas path temperature measurement from the engine from a point after changing the AISBV switch status.

9. A method as recited in claim 8, further comprising comparing the current engine system data to the baseline data, wherein comparing the current engine system data to the baseline data includes determining a difference between the torque measurement from the point after changing the AISBV switch status and the torque measurement from the point before changing the AISBV switch status and comparing the difference to a pre-determined torque threshold.

10. A method as recited in claim 9, further comprising determining an elapsed time between when the baseline data was retrieved and when the current engine system data was retrieved if the difference between the torque measurement from the current engine system data and the torque measurement from the baseline data is greater than the pre-determined torque threshold, and comparing the elapsed time with a pre-determined elapsed time threshold.

11. A method as recited in claim 10, further comprising generating a no-fault condition indicator if the elapsed time is less than the pre-determined elapsed time threshold.

12. A method as recited in claim 10, further comprising generating a fault condition indicator where the AISBV status does not match the AISBV switch status and the elapsed time is greater than the pre-determined elapsed time threshold, wherein the AISBV status is at least one of open or closed, wherein the AISBV switch status is at least one of on or off, wherein the AISBV status does not match that of the AISBV switch when the AISBV switch status is on and the AISBV status is closed, or when the AISBV switch status is off and the AISBV status is open.

13. A method as recited in claim 9, further comprising determining an elapsed time between when the baseline data was retrieved and when the current engine system data was retrieved if the difference between the torque measurement from the current engine system data and the torque measurement from the baseline data is less than the pre-determined torque threshold, and comparing the elapsed time with at least one of first and second pre-determined elapsed time thresholds.

14. A method as recited in claim 13, further comprising generating a no-fault condition indicator if the elapsed time is less than the first pre-determined elapsed time threshold.

15. A method as recited in claim 14, further comprising generating a no-fault condition indicator where the AISBV status matches the AISBV switch status and the elapsed time is between the first and second pre-determined elapsed time thresholds, wherein the AISBV status is at least one of open or closed, wherein the AISBV switch status is at least one of on or off, wherein the AISBV status matches that of the AISBV switch when the AISBV switch status is on and the AISBV status is open, or when the AISBV switch status is off and the AISBV status is closed.

16. A method as recited in claim 14, further comprising generating a fault condition indicator when the elapsed time is between the first and second pre-determined elapsed time thresholds, and where the AISBV status does not match the AISBV switch status, wherein the AISBV status is at least one of open or closed, wherein the AISBV switch status is at least one of on or off, wherein the AISBV status does not match the AISBV switch status when the AISBV switch status is on and the AISBV status is closed, or when the AISBV switch status is off and the AISBV status is open.

17. A method as recited in claim 13, wherein comparing the current engine system data to the baseline data includes determining a change in gas path temperature between the gas path temperature measurement from the current engine system data and the gas path temperature measurement from the baseline data if the elapsed time is greater than the second pre-determined elapsed time threshold, and comparing the change in gas path temperature to a pre-determined gas path temperature change threshold.

18. A method as recited in claim 17, further comprising generating a fault condition indicator if at least one of the change in gas path temperature is less than the pre-determined gas path temperature change threshold, or if the AISBV status does not match the AISBV switch status, wherein the AISBV status is at least one of open or closed, wherein the AISBV switch status is at least one of on or off, wherein the AISBV status does not match that of the AISBV switch when the AISBV switch status is on and the AISBV status is closed, or when the AISBV switch status is off and the AISBV status is open.

19. A method as recited in claim 17, further comprising generating a no-fault condition indicator if the change in gas path temperature is greater than the pre-determined gas path temperature change threshold and if the AISBV status matches the AISBV switch status, wherein the AISBV status is at least one of open or closed, wherein the AISBV switch status is at least one of on or off, wherein the AISBV status matches that of the AISBV switch when the AISBV switch status is on and the AISBV status is open, or when the AISBV switch status is off and the AISBV status is closed.

20. An anti-ice/start bleed valve assessment system comprising:
an AISBV assessment module configured to be operatively connected to a plurality of sensors, wherein the AISBV assessment module includes a processor operatively connected to a memory, wherein the memory includes instructions recorded thereon that, when read by the processor, cause the processor to:
determine an operating mode of an engine;
retrieve current engine system data associated with the operating mode; and
indicate whether an anti-ice/start bleed valve (AISBV) is functioning properly based on the current engine system data.
